(19) United States
(12) Patent Application Publication
(10) Pub. No.: US 2018/0167781 A1
(43) Pub. Date: Jun. 14, 2018

(54) Multi-Agent System for Global Positioning Syste (GPS) Web Services

(71) Applicant: Glen Harding, Ladera Ranch, CA (US)

(72) Inventor: Glen Harding, Ladera Ranch, CA (US)

(21) Appl. No.: 15/513,810

(22) PCT Filed: Aug. 2, 2016
(86) PCT No.: PCT/US16/45074

§ 371 Date: Mar. 23, 2017

(51) Int. Cl. H04W 4/02; G06F 17/30; G06Q 50/30

(52) U.S. Cl. CPC H04W 4/025; G01S 19/42; G06Q 50/30; G06F 17/3087

(57) ABSTRACT

The present invention is an internet communications and coordination system for providing demographic transport and shipments services. Multi-agent technology comprises the web server, vehicle, and customer applications of the internet system. Moreover, relational database technology manages and automates the sytem. Importantly, the vehicles and customers in the system are sorted by their dynamic Global Positioning System (GPS) coordinates to automatically set up real-time transport and shipments propositions. And moreover, the GPS datagrams of the vehicles and customers interface to Geographic Information Systems (GIS) databases and web services for mapping, navigation, and ecommerce user interfaces. For example, a GIS map is drawn using the customer's GPS datagram for the map center point. Next, available vehicles are sorted by closest distance to the customer and offered as a proposition for transport services. Therefore, the system automatically creates ecommerce propositions based on dynamic closest distance between transport vehicles and mobile customers. In a preferred embodiment, the customer selects and contracts one of the closest vehicles which then navigates to the customer's current GPS position to provide the contracted transport services.

### TECHNICAL FIELD

The present invention comprises internet communications technology for enabling dynamic transport services for mobile customers. It is further related to web services technology for providing commercial ecommerce in the transport services and shipments industries. Moreover, in a preferred embodiment multi-agent technology comprises the internet web server and the internet applications for the vehicles and customers. Furthermore, the multi-agent web server utilizes relational database technology for automating the system and processing enterprise data. And importantly, the current invention is based on the Global Positioning System (GPS) for the three-dimensional coordinate system to model the system transport vehicles and demographic consumers. And moreover, the invention interfaces to GPS related web services including Geographic Information Systems (GIS) mapping and navigation technology. And furthermore, GPS data is used to access location information such as current traffic and therefore the invention is further related to the field of semantic web services applied to the transport services and shipments industries.

### BACKGROUND ART

Prior art for the current invention includes the applicant's software and report titled “Global Positioning System (GPS) Multi-Agent Simulation”, dated 25 Jun. 2008. The applicant discloses a system for arranging dynamic transport between a mobile customer and a fleet of transport vehicles.

Further background art is the applicant's software and report titled “Multi-Agent System for Global Positioning System (GPS) Web Services”, dated 30 Jul. 2008. The applicant discloses an internet system for arranging transport services between mobile customers and a fleet of passenger vehicles registered on a GPS ecommerce web server.

### SUMMARY OF INVENTION

### Technical Problem

The problem addressed is how to provide as near real-time response as possible to consumer requests for transport and delivery services. Therefore the current invention addresses the physical problem of connecting transport vehicles to the dynamic locations of customers.

### Solution to Problem

To achieve optimal responses to consumer requests for transport services a communications platform between the system vehicles and the customers is needed. The internet platform is chosen because it fits the needs of consumers and makes the transport service global in scope. Furthermore, web services is the selected communications protocol. It is device independent and interfaces with needed internet services such as mapping.

Moreover, multi-agent technology comprises the vehicle and customer applications for arranging transport services. And furthermore, multi-agent technology comprises the ecommerce web server for running the transport service enterprise including communications with and coordination of transport vehicles and mobile customers.

Furthermore, the current invention utilizes the Global Positioning System (GPS) coordinate system. Each vehicle and customer agent time-samples GPS data including current longitude, latitude, altitude, heading, speed, and time. Importantly, each vehicle and customer agent is mapped to its current time-frame GPS datagram and its location context. Therefore, from the dynamic GPS datagrams of the fleet of vehicles and the customer's current location, the fastest arriving vehicle is calculated and selected to provide the transport service.

And moreover, relational database technology is used to automate transport service contract formation. For example, when a customer demands transport service, the passenger vehicles are automatically sorted by closest distance to the customer and offered as a transport proposal. In sum, the current invention provides optimized vehicle responses to consumer requests for transport services primarily by dynamic GPS datagram sorting of the vehicles and customers.

### Advantageous Effects of Invention

One advantage of the current invention is the competitive edge a transport enterprise gains by providing automated and optimal vehicle responses to consumer requests for transport or shipments services. The effect is the transport enterprise provider and the customers save time. Furthermore, the vehicles track to the dynamic GPS datagram of the customer and therefore the transport service increases customer convenience. In general, the invention is designed to automatically select the fastest arriving vehicle for a transport services request and therefore the effect is efficient usage of the vehicle and faster arrival times to the customers pickup location.

And furthermore, the invention helps solve the problem of managing a fleet of vehicles by automating dispatch. Customer demand for transport is dynamic and the GPS ecommerce server responds with the best utilization of its service vehicles automatically. And most importantly, the current invention works as a mechanism for automatically generating transport service propositions for each customer and the advantageous effect is revenue from contracted transport services.

### DESCRIPTION OF EMBODIMENTS

The web server, vehicles, and customers of the internet system communicate extensively based on GPS datagrams and multi-agent technology. First, an Internet web server is built for ecommerce web services and then integrated with multi-agent technology. Next, the multi-agent server is integrated with relational database technology to automate the system primarily by GPS datagram sorting.

Therefore, all embodiments of the current invention are based on an ecommerce agent running on an internet web server that manages the communications and coordination between registered vehicle and customer multi-agents. Furthermore, this executive web server agent maintains a searchable directory of all the vehicles and customers and interfaces with database technology for processing the transport enterprise data. Moreover, user interfaces for the server console and the vehicle and customer internet browser applications are created primarily from server side generated relational tables. And in a preferred embodiment, raw GPS—or other location means—data is further processed to interface with standard GIS and web services mapping and navigation software.

The vehicle multi-agent application runs on a cell phone or other internet technology and represents, in one embodiment, a single driver. However way the driver is traveling, by motorbike, car, truck—whatever transport means by land, water, or air—it is the driver's internet device that is tracked. In an alternative embodiment, a vehicle agent is embedded in and corresponds to a specific vehicle and tracked independently.

The vehicle application connects to a GPS web server and registers itself as a vehicle including details like type and cost. A vehicle agent de-registers when out of service and also changes state from, for example, available to contracted. In a preferred embodiment, a vehicle agent time-samples GPS datagrams and processes and stores this data on the local device. Moreover, the vehicle agent constantly checks for messages from customers or the executive web server agent. If there is a customer message, for example, it contains the current GPS datagram for the pickup location. The message may also hold other information including drop-off coordinates.

Therefore, the vehicle agent must decide how to act on the message from a potential customer. For example, one automatic rule is that the vehicle, when available, bid on all transport requests when the customer pickup point is less than or equal to 1 mile away. The vehicle can therefore ignore or act on the customer message based on this or more complex rule.

If the vehicle decides to act on the customer's request for transport, this vehicle sends a proposal to the customer including costs. This vehicle agent then constantly checks for the customer's response to the proposal. In particular, if the customer's response is to accept the proposal, then the vehicle agent sends back a confirmation message to the customer. Then, in a preferred embodiment, the contracted vehicle and customer open direct communications and track each other to fulfillment of the transport contract.

In general, the customer multi-agent application runs on a cell phone or other personal internet technology and is used to secure dynamic transport and shipments services. In one embodiment, the application connects to a GPS web server and communicates its current location. The server sorts the available vehicles and dispatches the best-fit transport service automatically. Therefore, in this embodiment, the only user interaction required is any tracking and messaging between the consumer and the contracted vehicle. In further embodiments of the user interface, web services are used for GIS, navigation, and rendering the three-dimensional GPS data.

For enabling transport systems, a primary behavior of the customer application is time-sampling and communicating its current GPS datagram and agent identifier. In further embodiments for identification and communications, internet device audio and video is time-sampled together with the GPS datagram. The list of vehicles for a customer is periodically updated due to the fact that the availability of uncontracted vehicles changes dynamically.

In one customer interface, a GIS map is centered on the customer's current GPS datagram and the closest available transport vehicles then presented for selection. If the customer selects and contracts one of the vehicles, it pairs with the customer for messaging and tracking the contract to fulfillment including payment.

And furthermore, the current invention is a dynamic supply and demand based system. System performance is based on the fact that the number of vehicles is proportional to the number of customers. Too many vehicles is unprofitable for the transport provider and too few is inefficient for the consumer wanting rapid response. In one ecommerce embodiment, vehicle supply and demand is handled by competitive bids and quotes. Moreover, vehicle response time is improved with algorithms that balance vehicles to customers.

Furthermore, diverse ecommerce models are enabled by GPS web services. For example, with a public GPS web server anyone with a passenger vehicle and a cell phone can offer transport services. When a customer connects to this GPS site, the vehicles are sorted relative to the customer and offered for transport hire. In contrast, a private system for GPS web services has specialized vehicles including trained and vetted drivers.

### INDUSTRIAL APPLICABILITY

In a preferred embodiment, the current invention is designed for automatic and optimal selection of vehicles for responding to consumer requests for transport and shipment services.

For illustration, a water transport embodiment uses jet-skis for passenger and shipment vehicles and surfers and swimmers are the customers. The customers run their GPS application on internet wristwatches. The Jet-ski vehicles run their GPS application on cell phones or tablets. Anytime a swimmer or surfer triggers a request for transport using the wristwatch interface the closest jetski is calculated and selected to navigate to the customer and provide transport. The same principles apply for delivery of goods. And moreover, the principles apply to any type of passenger or delivery vehicle.

The goal of a GPS ecommerce server is forming contracts for transport between vehicles registered on the server and customers that connect to it. For example, if a customer specifically requires motorcycle transport, then the GPS server agent first searches only for vehicles that are registered as motorcycles. A relational table of available motorcycles is generated. Then, using the real-time GPS coordinates of these motorcycles, they are sorted by closest distance or fastest arrival time to the customer's dynamic location. The motorcycle that is the best-fit to the customer's GPS pickup location—including route, cost, and time factors—wins and is automatically selected. Alternatively, the top closest candidates are given as a list for the customer to select from.

In general, a GPS server agent calculates and communicates a list of the closest vehicles that match a customer's request for transport service. Furthermore, this list allows direct communications between the customer and these transport service vehicles. For illustration, the customer's current GPS datagram is placed in a message with any other information like drop-off location and sent to all the vehicles in this list. The customer agent repeatedly checks for a vehicle reply. If a message arrives and its performative is Propose, then this vehicle is offering transport and bids on the service based on the customer's transport service requests. The customer can refuse, negotiate, or accept the proposal. If the customer accepts the bid for transport, an Accept Proposal performative is communicated to this winning vehicle. The customer agent checks for the final part of the ecommerce semaphore for securing a transport-shipment vehicle: confirmation from the vehicle agent that it is now contracted and committed to navigating to the customer's target GPS position.

What is claimed is:

1. A communications and coordination system comprising an internet web server that handles incoming client connections in an infinite loop;
wherein said web server client connections are handled by independent process threads;
wherein said client connections are adapted for a vehicle internet application for providing transport and delivery services;
wherein said client connections are adapted for a customer internet application for contracting transport and delivery services;
wherein said web server maintains a searchable directory of said vehicles and customers including their descriptive information;
wherein said vehicles and customers communicate to said server their identifier and location datagrams selected from, but not limited to, longitude, latitude, altitude, speed, heading, date, and time;
wherein said web server sorts the vehicles and customers based on web services requests and the current location datagrams of the vehicles and customers and communicates the results back to the requesting client;

2. The invention according to claim 1 wherein said web server comprises multi-agent technology;

3. The invention according to claim 1 wherein said vehicle application comprises multi-agent technology;

4. The invention according to claim 1 wherein said customer application comprises multi-agent technology;

5. The invention according to claim 1 wherein said web server processes system data using relational database technology;

6. The invention according to claim 1 wherein said customers are sorted by closest distance to the current location of an individual vehicle;

7. The invention according to claim 1 wherein said vehicles are sorted by closest distance to the current location of an individual customer;

8. The invention according to claim 1 wherein said vehicles are sorted relative to an individual customer by factors such as fastest arrival time and lowest cost;

9. The invention according to claim 1 wherein said customers are sorted relative to said vehicle by factors such as fastest arrival time and highest profit;

10. The invention according to claim 1 wherein a Geographic Information Systems (GIS) map is drawn using said vehicle's current GPS datagram as the map center point and the closest customers plotted according to their dynamic datagrams and descriptions;

11. The invention according to claim 1 wherein a Geographic Information Systems (GIS) map and interaction interface is drawn using said customer's current GPS datagram as the map center point and the closest vehicles plotted according to their dynamic datagrams and descriptions;

12. The invention according to claim 1 wherein said vehicles and customers are dynamically updated on said web server user interface;

13. The invention according to claim 1 wherein hyper text transfer protocol secure (HTTPS) is used for said internet communications;

14. The invention according to claim 1 wherein said vehicle and customer applications communicate audio and video streams;

15. The invention according to claim 1 wherein said customer web services request and current location is given to more than one vehicle for the purpose of requesting competitive price quotes;

16. The invention according to claim 1 wherein said vehicle current location and service description is given to more than one customer for the purpose of requesting competitive price bids;

17. The invention according to claim 1 wherein if said customer selects and contracts one of the transport vehicles, the selected vehicle opens communication with and navigates to the customer's location to fulfill the transport service contract including payment.
